(19) United States
(12) Patent Application Publication
(10) Pub. No.: US 2012/0212182 A1
(43) Pub. Date: Aug. 23, 2012

(54) BATTERY SYSTEM WITH BALANCE FUNCTION

(75) Inventor: Zhen Li, Hangzhou (CN)

(73) Assignee: Chengdu Monolithic Power Systems Co., Ltd.

(21) Appl. No.: 13/401,695

(22) Filed: Feb. 21, 2012

(30) Foreign Application Priority Data
Feb. 21, 2011 (CN) 201110042752.0

(51) Int. Cl. H02J 7/00

(52) U.S. Cl. 320/116

(57) ABSTRACT

The embodiments of the present disclosure disclose a battery system. The battery system at least comprises a battery pack, an inductor and two sets of switch branches. The battery system controls the inductor to store and release energy, so as to transfer energy between the battery pack and a battery cell or between two battery cells.

### CROSS-REFERENCE TO RELATED APPLICATION(S)

This application claims the benefit of CN application No. 201110042752.0, filed on Feb. 21, 2011, and incorporated herein by reference.

### TECHNICAL FIELD

The present disclosure relates generally to battery systems, and more particularly but not exclusively to battery systems with balance function.

### BACKGROUND

A battery pack usually comprises several battery cells connected in series. In the battery pack, a cell imbalance may occur due to the differences in the characteristics of the battery cells, such as the charge states, cell capacities, temperature characteristics, etc. This imbalance will shorten the battery life and reduce the capacity of the entire battery pack.

FIG. 1 schematically shows a prior battery system 10 with a passive balance circuit. As illustrated in FIG. 1, bypass resistors and bypass FETs (field effect transistor) are connected to the corresponding battery cells in parallel. When the voltage across one battery cell is higher than that of the rest battery cells, the battery cell with higher voltage is discharged through the corresponding bypass resistors and FET. The battery system 10 of FIG. 1 can only adjust the battery cell having a higher voltage and its efficiency is low.

FIG. 2 schematically shows a prior battery system 20 with an active balance circuit. As illustrated in FIG. 2, the battery system 20 comprises capacitors coupled between every two adjacent battery cells. The capacitor stores and releases energy to balance the corresponding two adjacent battery cells. The battery system 20 of FIG. 2 can only balance two adjacent battery cells. Furthermore, the efficiency of the battery system 20 is low since a lot of energy is wasted during the charge of the capacitors.

FIG. 3 schematically shows another prior battery system 30 with an active balance circuit. As illustrated in FIG. 3, the battery system 30 comprises a transformer and energy can be transferred from the battery pack to an individual battery cell through the transformer. However, the size and the cost of the battery system are increased because of the transformer.

FIG. 4 schematically shows still another prior battery system 40 with an active balance circuit. As illustrated in FIG. 4, the battery system 40 comprises several inductors and the battery cell system 40 can work as a buck-boost converter to transfer energy between two adjacent battery cells. The battery system 40 of FIG. 4 can only balance two adjacent battery cells and its efficiency is limited.

### SUMMARY

The present invention is directed to a battery system comprising a battery pack, a first set of N switch branches, a second set of N switch branches, an inductor, a first switch, a second switch, a third switch and a fourth switch. The battery pack comprises N battery cells connected in series, and each of the battery cells has an anode and a cathode. Each switch branch has a first terminal and a second terminal. The first terminals of the first set of N switch branches are coupled together to form a first common node, and the second terminals of the first set of N switch branches are coupled to the anode of the N battery cells respectively. The first terminals of the second set of N switch branches are coupled to the cathode of the N battery cells respectively, and the first terminals of the second set of N switch branches are coupled together to form a second common node. The first switch having a first terminal and a second terminal, wherein the first terminal is coupled to the anode of the battery pack, the second terminal is coupled to the first terminal of the inductor. The second switch having a first terminal and a second terminal, wherein the first terminal is coupled to the first common node, the second terminal is coupled to the second terminal of the inductor. The third switch having a first terminal and a second terminal, wherein the first terminal is coupled to the first terminal of the inductor, the second terminal is coupled to the second common node. The fourth switch having a first terminal and a second terminal, wherein the first terminal is coupled to the second terminal of the inductor, the second terminal is coupled to the cathode of the battery pack.

The present invention is also directed to a battery system comprising a battery pack, a first set of N+1 switch branches, a second set of N+1 switch branches and an inductor. The battery pack having an anode and a cathode, wherein the battery pack comprises N battery cells connected in series, and each of the battery cells has an anode and a cathode. Each switch branch has a first terminal and a second terminal. The first terminals of the first set of N+1 switch branches are coupled together to form a first common node. The second terminals of the first N switch branches of the first set of N+1 switch branches are coupled to the anode of the N battery cells respectively, and the second terminal of the last switch branch of the first set of N+1 switch branches is coupled to the cathode of the last battery cell. The first terminals of the first N switch branches of the second set of N+1 switch branches are coupled to the anode of the N battery cells respectively, and the first terminal of the last switch branch of the second set of N+1 switch branches is coupled to the cathode of the last battery cell. The second terminals of the second set of N+1 switch branches are coupled together to form a second common node. The inductor has a first terminal and a second terminal, wherein the first terminal of the inductor is coupled to the first common node, and the second terminal of the inductor is coupled to the second common node.

The present invention is further directed to a battery system with stackable connection comprising M battery balance units and M−1 pairs of diodes. Each pair of the diodes comprises a first diode and a second diode, and wherein the cathode of the first diode is coupled to the anode of the battery pack of the corresponding battery balance unit, and the anode of the first diode is coupled to the second terminal of the inductor of the next battery balance unit, the cathode of the second diode is coupled to the first terminal of the inductor of the corresponding battery balance unit, and the anode of the second diode is coupled to the cathode of the battery pack of the next battery balance unit.

### BRIEF DESCRIPTION OF THE DRAWINGS

FIG. 1 schematically shows a prior battery system 10 with a passive balance circuit.

FIG. 2 schematically shows a prior battery system 20 with an active balance circuit.

FIG. 3 schematically shows another prior battery system 30 with an active balance circuit.

FIG. 4 schematically shows still another prior battery system 40 with an active balance circuit.

FIG. 5 schematically shows a battery system 50 in accordance with an embodiment of the present disclosure.

FIG. 6a shows waveforms of the battery system 50 of FIG. 5 when energy is transferred from a battery cell to battery pack.

FIG. 6b and FIG. 6c show the operation of the battery system 50 of FIG. 5 when energy is transferred from a battery cell to the battery pack.

FIG. 7a shows waveforms of the battery system 50 of FIG. 5 when energy is transferred from the battery pack to a battery cell.

FIG. 7b and FIG. 7c show the operation of the battery system 50 of FIG. 5 when energy is transferred from the battery pack to a battery cell.

FIG. 8 schematically shows a battery system with N battery cells in accordance with an embodiment of the present disclosure.

FIG. 9 schematically shows an improved battery system 90 in accordance with another embodiment of the present disclosure.

FIG. 10 schematically shows an exemplary battery system 100 in accordance with an embodiment of the present disclosure.

FIG. 11 schematically shows an improved exemplary battery system 110 in accordance with an embodiment of the present disclosure.

FIG. 12a shows waveforms of the battery system 110 of FIG. 11 when energy is transferred from the battery pack to a battery cell.

FIG. 12b and FIG. 12c show the operation of the battery system 110 of FIG. 11 when energy is transferred from the battery pack to a battery cell.

FIG. 13a shows waveforms of the battery system 110 of FIG. 11 when energy is transferred from a battery cell to the battery pack.

FIG. 13b shows the operation of the battery system 110 of FIG. 11 when energy is transferred from a battery cell to the battery pack.

FIG. 14a shows waveforms of the battery system 110 of FIG. 11 when energy is transferred between two battery cells.

FIG. 14b shows the operation of the battery system 110 of FIG. 11 when energy is transferred between two battery cells.

FIG. 15 schematically shows a battery system 150 in accordance with an embodiment of the present disclosure.

FIG. 16 schematically shows an improved battery system 160 in accordance with an embodiment of the present disclosure.

FIG. 17a and FIG. 17b show the operation of the improved battery system 160 of FIG. 16.

FIG. 18 schematically shows a battery system 180 with stackable connection in accordance with an embodiment of the present disclosure.

FIG. 19 schematically shows an improved battery system 190 with stackable connection in accordance with an embodiment of the present disclosure.

FIG. 20a˜d show the operation of the improved battery system 190 of FIG. 19 when energy is transferred between two battery packs.

FIG. 21 schematically shows an improved battery system 210 with stackable connection in accordance with another embodiment of the present disclosure.

FIG. 22a˜d show the operation of the improved battery system 210 of FIG. 21 when energy is transferred between two battery systems.

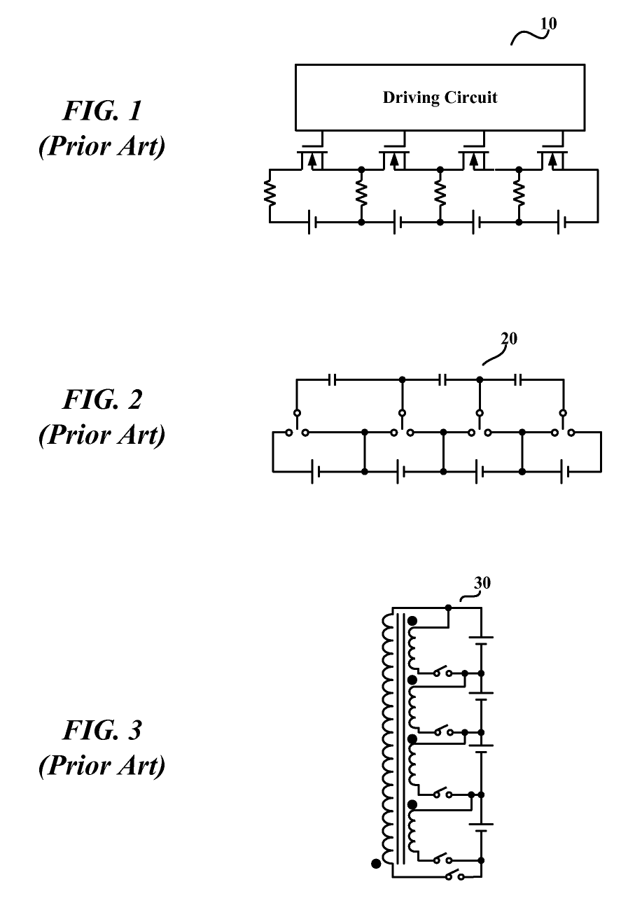

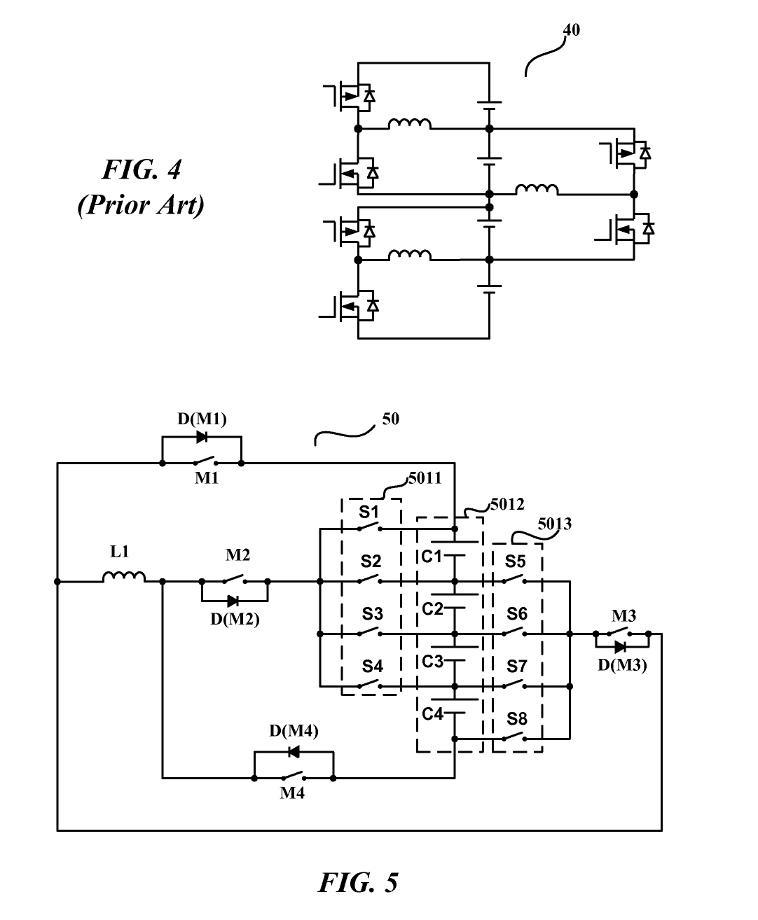

The use of the same reference label in different drawings indicates the same or like components.

### DETAILED DESCRIPTION

In the present disclosure, numerous specific details are provided, such as examples of circuits, components, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

FIG. 5 schematically shows a battery system 50 in accordance with an embodiment of the present disclosure. In the example of FIG. 5, the battery system 50 comprises an inductor L1, switches M1˜M4, a first set of switch branches 5011, a battery pack 5012 and a second set of switch branches 5013. The first set of switch branches 5011 comprises switch branches S1˜S4, the battery pack 5012 comprises battery cells C1˜C4 connected in series, and the second set of switch branches 5013 comprises switch branches S5˜S8. Each of the switch branches S1˜58 has a first terminal and a second terminal. The first terminals of the switch branches S1˜S4 are connected together to form a first common node. The second terminals of the switch branches S1˜54 are respectively coupled to the anodes of the battery cells C1˜C4. The first terminals of the switch branches S5˜S8 are respectively coupled to the cathodes of the battery cells C1˜C4 and the second terminals are connected together to form a second common node. The inductor L1 has a first terminal and a second terminal. The switch M1 is coupled between the first terminal of the inductor L1 and the anode of the battery pack 5012. The switch M2 is coupled between the second terminal of the inductor L1 and the first common node. The switch M3 is coupled between the first terminal of the inductor L1 and the second common node. The switch M4 is coupled between the second terminal of the inductor L1 and the cathode of the battery pack 5012.

In one embodiment, the battery system 50 further comprises diodes D(M1)˜D(M4) which are respectively coupled to the switches M1˜M4 in parallel. The cathode of the diode D(M1) is coupled to the anode of the battery pack 5012, and the anode of the diode D(M1) is coupled to the first terminal of the inductor L1. The cathode of the diode D(M2) is coupled to the first common node, and the anode of the diode D(M2) is coupled to the second terminal of the inductor L1. The cathode of the diode D(M3) is coupled to the first terminal of the inductor L1, and the anode of the diode D(M3) is coupled to the second common node. The cathode of the diode D(M4) is coupled to the second terminal of the inductor L1, and the anode of the diode D(M4) is coupled to the cathode of the battery pack 5012. In one embodiment, the diodes D(M1)˜D(M4) are the body diodes of the switches M1˜M4.

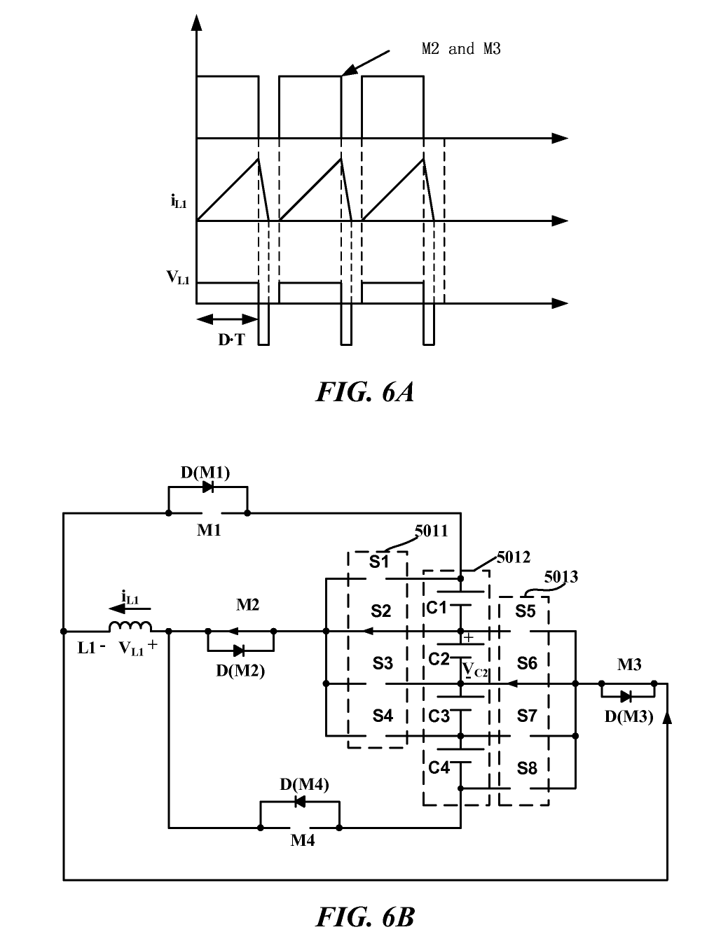

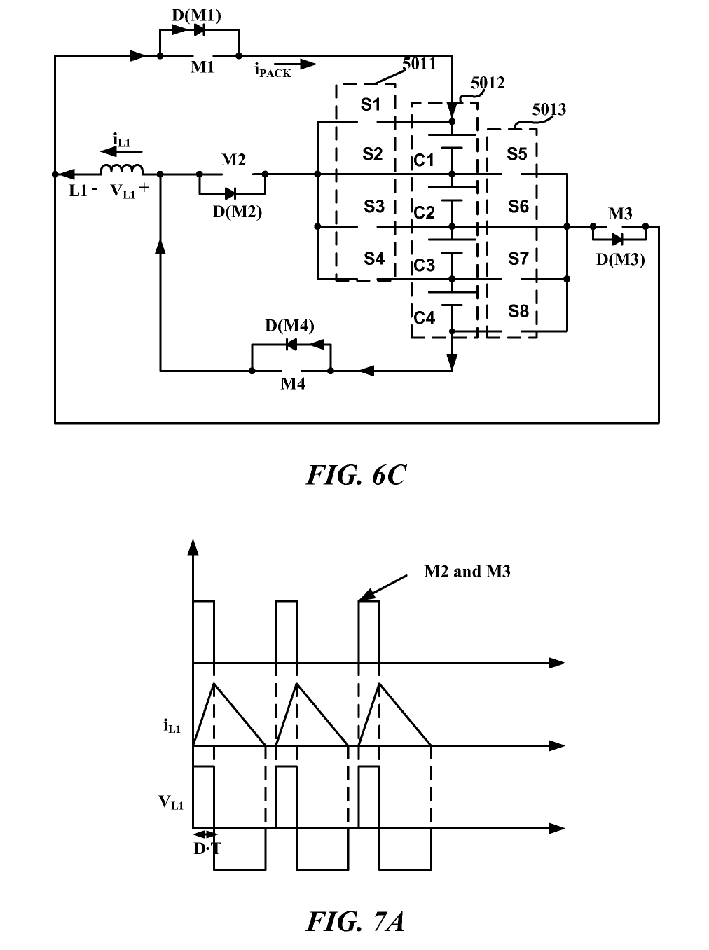

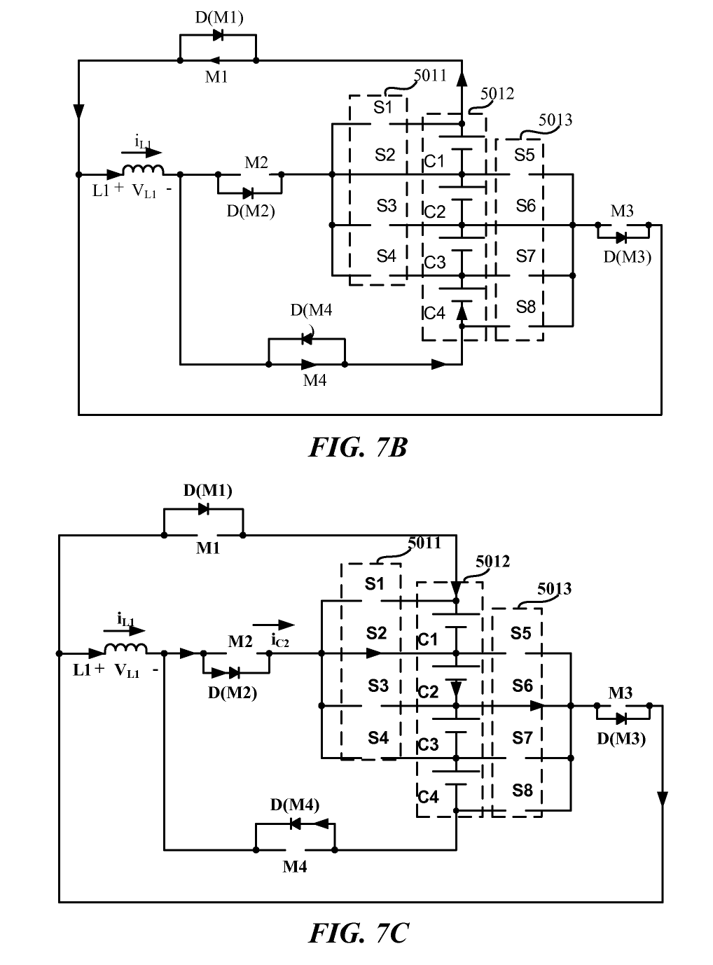

The operation of the battery system 50 is now explained with reference to FIG. 6˜FIG. 7.

When Energy is Transferred from a Battery Cell to the Battery Pack

The operation of the battery system 50 when energy is transferred from a battery cell to the battery pack 5012 is now explained with reference to FIG. 6a˜FIG. 6c. The battery system 50 transfers energy from a battery cell to the battery pack 5012 when the voltage of the battery cell is higher than the voltages of the rest battery cells. Take the battery cell C2 for example, when the voltage of C2 is higher than the voltages of the battery cells C1, C3 and C4, the switch branches S2 and S6 are turned on (i.e., closed) and the switch branches S1, S3˜S5, S7 and S8 are turned off (i.e., opened) to select the battery cell C2. Meanwhile, the switches M1 and M4 are turned off, and the switches M2 and M3 are turned on and off synchronously with a constant frequency and a constant duty cycle.

When the switches M2 and M3 are turned on, the operation of the battery system 50 is illustrated in FIG. 6b. Current flows from the anode of the battery cell C2, through the switch M2, the inductor L1 and the switch M3, and into the cathode of the battery cell C2. Thereby, energy is stored in the inductor L1. As shown in FIG. 6a, the voltage V_{L1} of the inductor L1 is equal to the voltage V_{C2} of the battery cell C2, i.e., V_{L1}=V_{C2}. The inductor current i_{L1} of the inductor L1 begins to increase and can be represented by the expression

$$\frac{{di}_{L 1}}{D \cdot T} = \frac{{V}_{C 2}}{L 1}$$

, wherein T represents the switching period of the switches M2 and M3, and D is the duty cycle.

When the switches M2 and M3 are turned off, the operation of the battery system 50 is illustrated in FIG. 6c. The inductor L1 begins to release energy with current flowing through the diode D(M1), the battery pack 5012 and the diode D(M4). As shown in FIG. 6a, the voltage V_{L1} of the inductor L1 and the voltage of the battery pack 5012 have a relationship expressed by V_{L1}=−V_{PACK}. The inductor current i_{L1} begins to decrease and can be represented by the expression

$$\frac{{di}_{L 1}}{( 1 - D ) \cdot T} = \frac{{V}_{PACK}}{L 1} .$$

When Energy is Transferred from the Battery Pack to a Battery Cell

The operation of the battery system 50 when energy is transferred from the battery pack 5012 to a battery cell is now explained with reference to FIG. 7a˜FIG. 7c. The battery system 50 transfers energy from the battery pack 5012 to a battery cell when the voltage of the battery cell is lower than the voltages of the rest battery cells. Take the battery cell C2 for example, when the voltage of C2 is lower than the voltages of the battery cells C1, C3 and C4, the switch branches S2 and S6 are turned on and the switch branches S1, S3˜S5, S7 and S8 are turned off to select the battery cell C2. Meanwhile, the switches M2 and M3 are turned off, and the switches M1 and M4 are turned on and off synchronously with a constant frequency and a constant duty cycle.

When the switches M1 and M4 are turned on, the operation of the battery system 50 is illustrated in FIG. 7b. Current flows from the anode of the battery pack 5012, through the switch M1, the inductor L1 and the switch M4, and into the cathode of the battery pack 5012. Thereby, energy is stored in the inductor L1. As shown in FIG. 7a, the voltage V_{L1} of the inductor L1 is equal to the voltage V_{PACK} of the battery pack 5012, i.e., V_{L1}=V_{PACK}. The inductor current i_{L1} of the inductor L1 begins to increase and can be represented by the expression

$$\frac{{di}_{L 1}}{D \cdot T} = \frac{{V}_{PACK}}{L 1} .$$

When the switches M1 and M4 are turned off, the operation of the battery system 50 is illustrated in FIG. 7c. The inductor L1 begins to release energy with current flowing through the diode D(M2), the battery cell C2 and the diode D(M3). As shown in FIG. 7a, the voltage V_{L1} of the inductor L1 and the voltage of the battery pack 5012 have a relationship expressed by V_{L1}=−V_{PACK}. The inductor current i_{L1} begins to decrease and can be represented by the expression

$$\frac{{di}_{L 1}}{( 1 - D ) \cdot T} = \frac{{V}_{PACK}}{L 1} .$$

As described above, the battery system 50 in accordance with an embodiment of the present disclosure can be employed to transfer energy between the battery pack and a battery cell. It is more effective compared with a prior battery system.

In the examples of FIG. 5˜FIG. 7, the operation of the battery system 50 is explained with the voltage of the battery cell C2 being higher or lower than that of the rest battery cells. As can be appreciated, the battery system 50 works in a similar way when the voltage of any one of the battery cells C1˜C4 is higher or lower than that of the rest battery cells.

In the examples of FIG. 5˜FIG. 7, the battery pack comprises 4 battery cells. However, persons of ordinary skill in the art can appreciate that in another embodiment, the battery pack may comprise N battery cells, where N is an integer greater than 2.

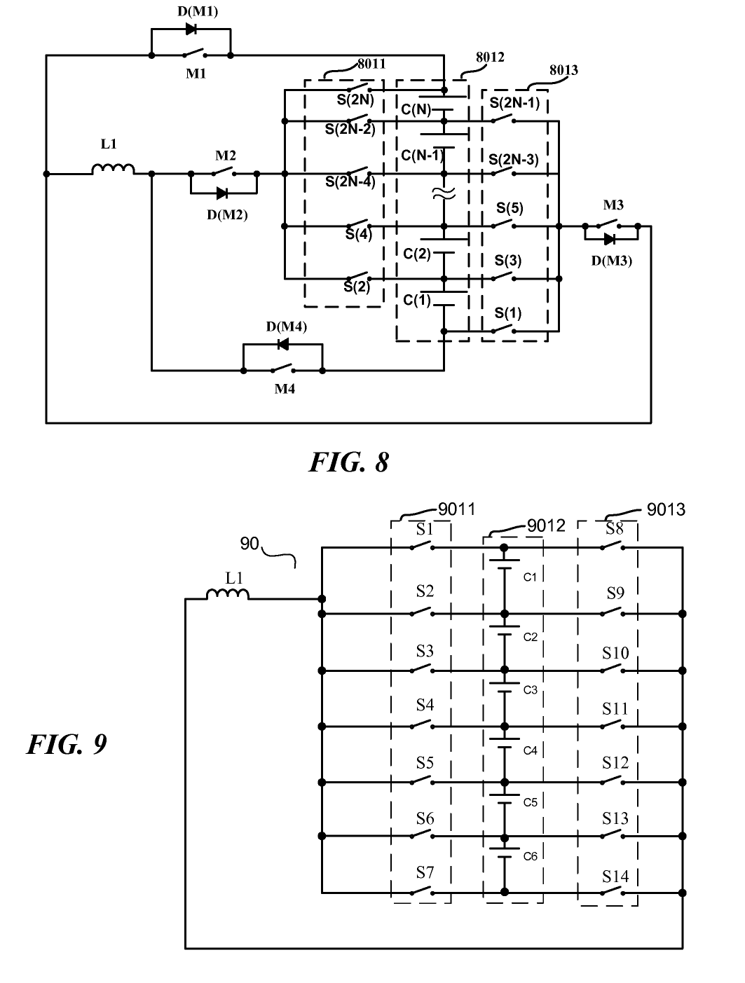

FIG. 8 schematically shows a battery system with N battery cells in accordance with an embodiment of the present disclosure. In the embodiment of FIG. 8, the first set of switch branches 8011 comprises N switch branches S(2), S(4), . . . , S(2N−2), S(2N), the second set of switch branches 8013 comprises N switch branches S(1), S(3), . . . , S(2N−3), S(2N−1). Each of the switch branches S1˜S(2N) has a first terminal and a second terminal. The first terminals of the switch branches S(2), S(4), . . . , S(2N) are coupled together to form a first common node. The second terminals of the switch branches S(2), S(4), . . . , S(2N) are respectively coupled to the anode of the battery cells C1˜C(N). The first terminals of the switch branches S(1), S(3), . . . , S(2N−3), S(2N−1) are respectively coupled to the cathode of the battery cells C1˜C(N) and the second terminals are coupled together to form a second common node. In one embodiment, each of the switch branches S1˜S(2N) may comprise a MOSFET and a diode serially connected to the MOSFET, or comprise a transistor or two MOSFETs connected back to back.

FIG. 9 schematically shows an improved battery system 90 in accordance with an embodiment of the present disclosure. The battery system 90 comprises a first set of switch branches 9011, a battery pack 9012, a second set of switch branches 9013 and an inductor L1. Further, the first set of switch branches 9011 comprises switch branches S1˜S7, the battery pack 9012 has an anode and a cathode, and the battery pack 9012 comprises battery cells C1˜C6 connected in series, and the second set of switch branches 9013 comprises switch branches S8˜S14. Each of the switch branches S1˜S14 has a first terminal and a second terminal. The first terminals of the switch branches S1˜S7 are connected together to form a first common node. The second terminals of the switch branches S1˜S6 are respectively coupled to the anodes of the battery cells C1˜C6, the second terminal of the switch branch S7 is coupled to the cathode of the battery cell C6. The first terminals of the switch branches S8˜S13 are respectively coupled to the anodes of the battery cells C1˜C6, the first terminal of the switch branch S14 is coupled to the cathode of the battery cell C6, and the second terminals of the switch branches S8˜S14 are connected together to form a second common node. The inductor L1 has a first terminal and a second terminal. The first terminal of the inductor L1 is coupled to the first common node, and the second terminal of the inductor L1 is coupled to the second common node.

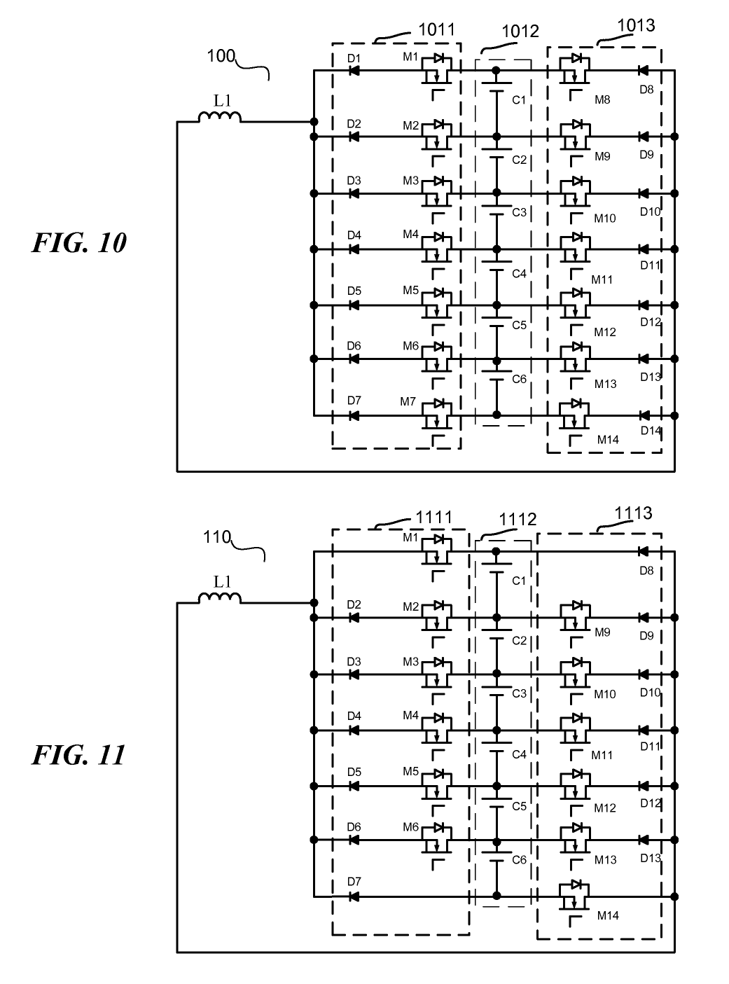

FIG. 10 schematically shows an exemplary battery system 100 in accordance with an embodiment of the present disclosure. In the exemplary battery system 100 of FIG. 10, each of the switch branches S1˜S14 comprises a MOSFET and a diode connected in series. Referring to FIG. 10, the switch branch S1 comprises a MOSFET M1 and a diode D1. The MOSFET M1 has a drain terminal, a source terminal and a gate terminal, and the diode D1 has an anode and a cathode. The anode of the diode D1 is coupled to the source terminal of the MOSFET M1. The cathode of the diode D1 is configured as the first terminal of the switch branch S1. The drain terminal of the MOSFET M1 is configured as the second terminal of the switch branch S1. The switch branches S2˜S7 are configured in the same way as the switch branch S1 is. The switch branch S8 comprises a MOSFET M8 and a diode D8. The MOSFET M8 has a drain terminal, a source terminal and a gate terminal, and the diode D8 has an anode and a cathode. The cathode of the diode D8 is coupled to the drain terminal of the MOSFET M8. The anode of the diode D8 is configured as the second terminal of the switch branch S8. The source terminal of the MOSFET M8 is configured as the first terminal of the switch branch S8. The switch branches S9˜S14 are configured in the same way as the switch branch S8 is.

FIG. 11 schematically shows an improved exemplary battery system 110 in accordance with an embodiment of the present disclosure. Compared to the battery system 100 of FIG. 10, the diodes D1 and D14, and the MOSFETs M7 and M8 are removed in the battery system 110 of FIG. 11. Since fewer components are used in the battery system 110, the size and cost of the system are both reduced and the efficiency is improved. Persons of ordinary skill in the art can appreciate that, in effect, battery systems 90, 100 and 110 operate in the similar way. The operation of these battery systems will be explained with reference to battery system 110 of FIG. 11.

When Energy is Transferred from the Battery Pack to a Battery Cell

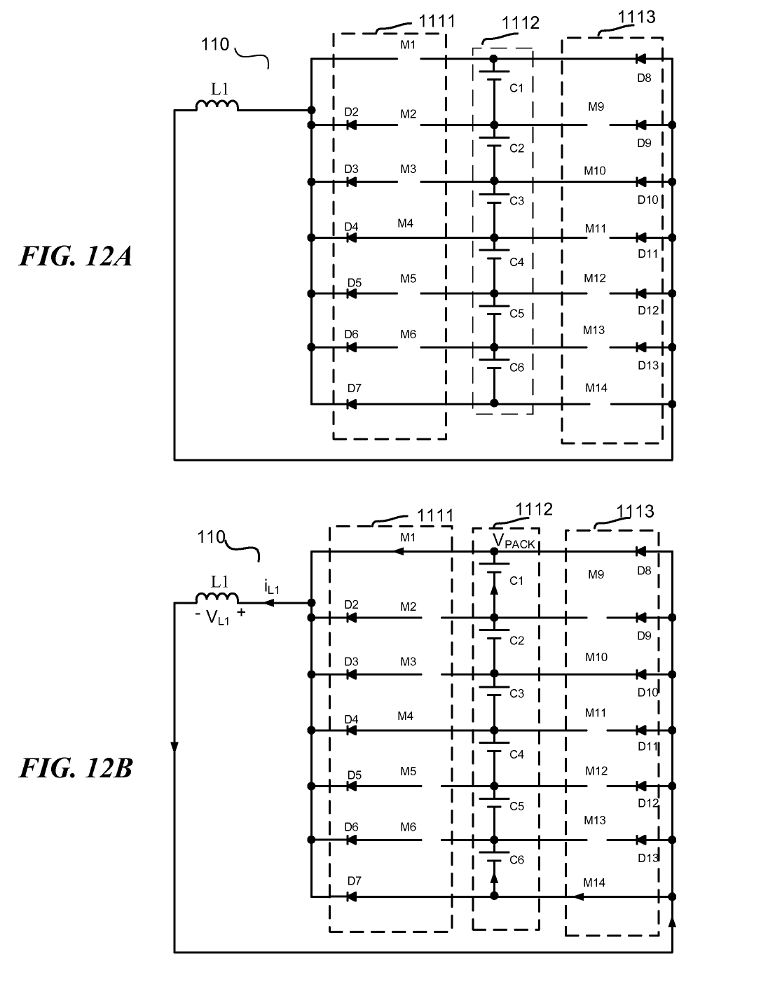

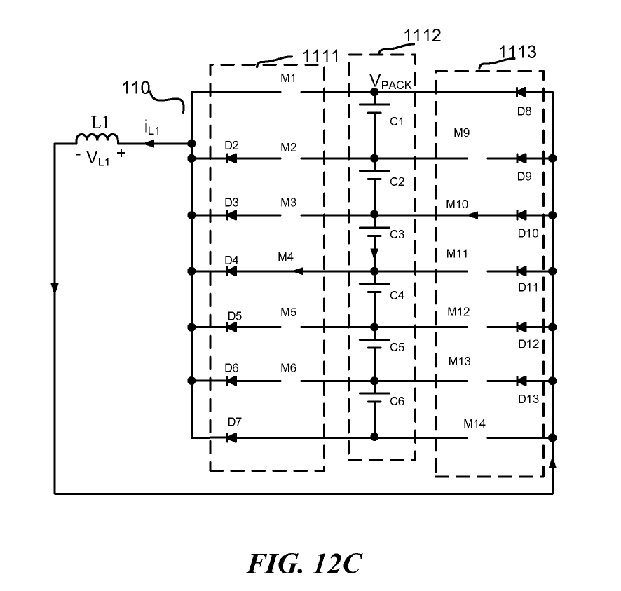

The operation of the battery system 110 when energy is transferred from the battery pack to a battery cell is now explained with reference to FIG. 12a˜FIG. 12c. The battery system 110 transfers energy from the battery pack to a battery cell when the voltage of the battery cell is lower than that of the rest battery cells. Take the battery cell C3 for example, when the voltage of C3 is lower than the voltages of the rest battery cells, the MOSFETs M4 and M10 are turned on, the MOSFETs M1 and M14 are turned on and off synchronously with a constant frequency and a constant duty cycle, and the rest MOSFETs are turned off.

When the MOSFETs M1 and M14 are turned on, the operation of the battery system 110 is illustrated in FIG. 12b. Current flows from the anode of the battery pack 1112, through the MOSFET M1, the inductor L1 and the MOSFET M14, and into the cathode of the battery pack 1112. Thereby, energy is stored in the inductor L1. The voltage V_{L1} of the inductor L1 is equal to the voltage V_{PACK} of the battery pack 1112, i.e., V_{L1}=V_{PACK}. The inductor current i_{L1} of the inductor L1 begins to increase.

When the MOSFETs M1 and M14 are turned off, the operation of the battery system 110 is illustrated in FIG. 12c. The inductor L1 begins to release energy, with current flowing through the diode D10, the MOSFET M10, the battery cell C3, the MOSFET M4 and the diode D4. The voltage V_{L1} of the inductor L1 and the voltage of the battery cell C3 have a relationship expressed by V_{L1}=−V_{C3}.

When Energy is Transferred from a Battery Cell to the Battery Pack

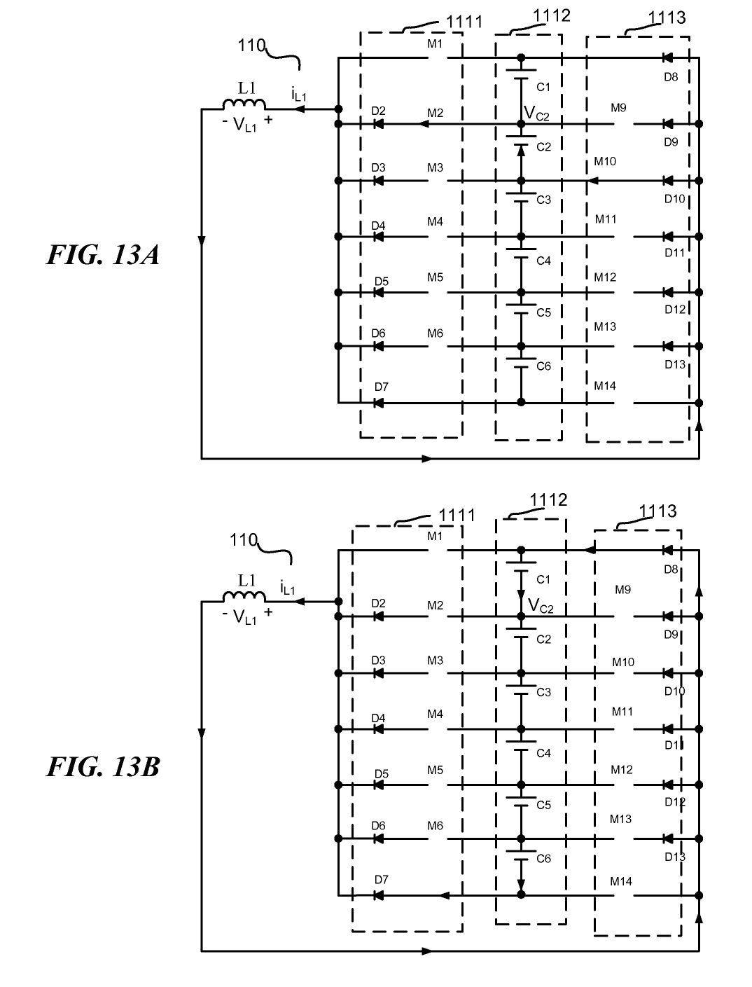

The operation of the battery system 110 when energy is transferred from a battery cell to the battery pack is now explained with reference to FIG. 13a˜FIG. 13b. The battery system 110 transfers energy from a battery cell to the battery pack when the voltage of the battery cell is higher than that of the rest battery cells. Take the battery cell C2 for example, when the voltage of C2 is higher than the voltages of the rest battery cells, the MOSFETs M2 and M10 are turned on and off synchronously with a constant frequency and a constant duty cycle, and the rest MOSFETs are turned off. When the MOSFETs M2 and M10 are turned on, the operation of the battery system 110 is illustrated in FIG. 13a. Current flows from the anode of the battery cell C2, through the MOSFET M2, the diode D2, the inductor L1, the diode D10 and the MOSFET M10, and into the. Thereby, energy is stored in the inductor L1. The voltage V_{L1} of the inductor L1 equals to the voltage V_{C2} of the battery cell C2, i.e., V_{L1}=V_{C2}. The inductor current i_{L1} of the inductor L1 begins to increase. When the MOSFETs M2 and M10 are turned off, the operation of the battery system 110 is illustrated in FIG. 13b. The inductor L1 begins to release energy, with current flowing through the diode D8, the battery pack 1112 and the diode D7. The voltage V_{L1} of the inductor L1 and the voltage of the battery pack 1112 have a relationship expressed by V_{L1}=−V_{PACK}.

When Energy is Transferred from a Battery Cell to Another Battery Cell

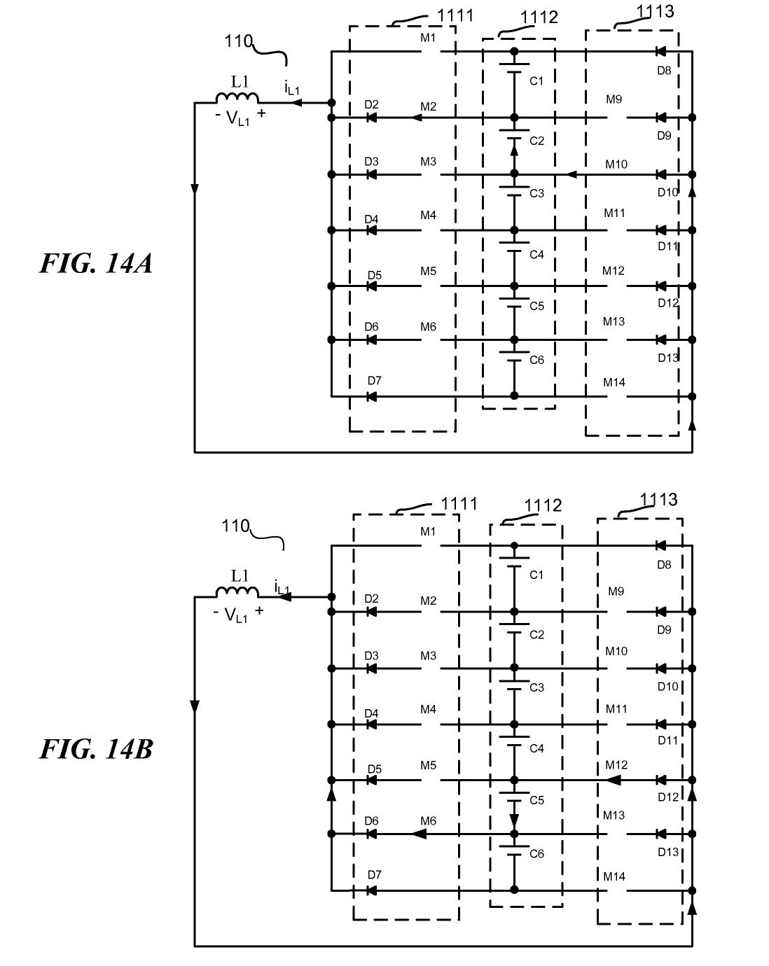

The operation of the battery system 110 when energy is transferred from a battery cell to another battery cell is now explained with reference to FIG. 14a˜FIG. 14b. The battery system 110 transfers energy from a battery cell to another battery cell when the voltage of one battery cell is higher than that of the rest battery cells and the voltage of another battery cell is lower than that of the rest battery cells. Take the battery cells C2 and C5 for example, when the voltage of C2 is higher than the voltages of the rest battery cells and the voltage of C5 is lower than the voltages of the rest battery cells, the MOSFETs M2 and M10 are turned on first, and the rest MOSFETs are turned off to choose the battery cell C2. When the MOSFET M2 and M10 are turned on, the operation of the battery system 110 is illustrated in FIG. 14a. Current flows out from the anode of the battery cell C2, through the MOSFET M2, the diode D2, the inductor L1, the diode D10 and the MOSFET M10. Thereby, energy is stored in the inductor L1. The voltage V_{L1} of the inductor L1 equals to the voltage V_{C2} of the battery cell C2, i.e., V_{L1}=V_{C2}. The inductor current i_{L1} of the inductor L1 begins to increase.

The MOSFETs M2 and M10 are turned on until the voltage of C2 is equal to the voltages of the rest battery cells. Then, as illustrated in FIG. 14b, the MOSFETs M2 and M10 are turned off, the MOSFETs M6 and M12 are turned on, and the rest MOSFETs are turned off. The inductor L1 begins to release energy, with current flowing through the diode D12, the MOSFET M12, the battery cell C5, the MOSFET M6 and the diode D6. The voltage V_{L1} of the inductor L1 and the voltage of the battery cell C5 have a relationship expressed by V_{L1}=−V_{C5}.

Complementary charge is to charge each battery cell to a common full voltage in the charge stage, i.e., to charge each battery cell to a balance state in the charge stage.

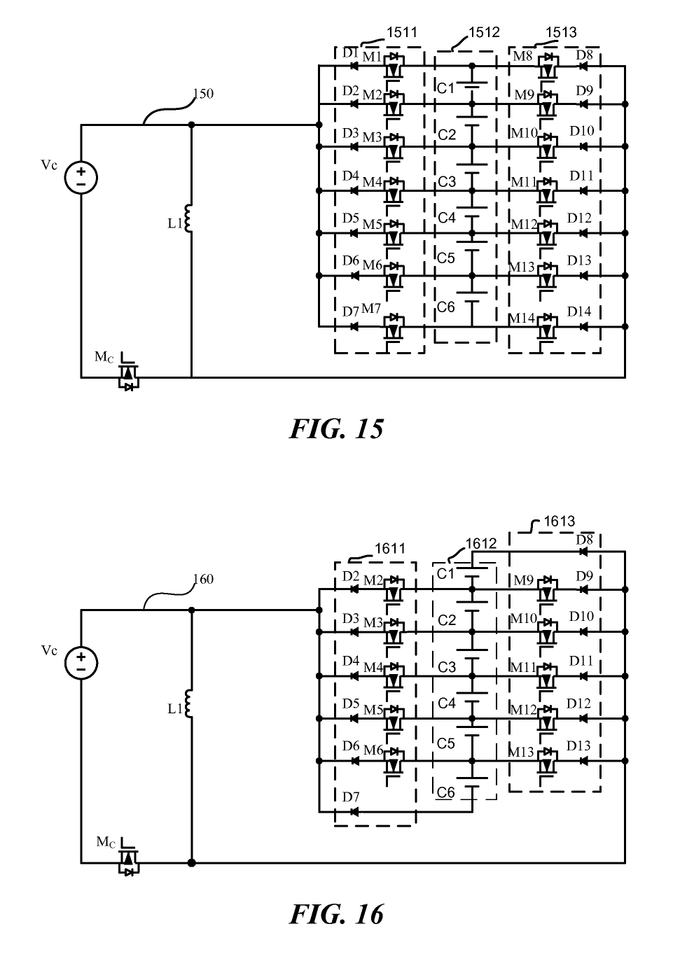

FIG. 15 schematically shows a battery system 150 in accordance with an embodiment of the present disclosure. Compared to the battery system 100 of FIG. 10, a voltage source V_{C} and a MOSFET M_{C} are added in the battery system 150 of FIG. 15. Referring to FIG. 15, the voltage source V_{C} and the MOSFET M_{C} are connected in series, and they are connected with the inductor L1 in parallel. In detail, the voltage source V_{C} has an anode and a cathode, and the MOSFET M_{C} has a source terminal, a drain terminal and a gate terminal. The anode of the voltage source V_{C} is coupled to the first terminal of the inductor L1. The cathode of the voltage source V_{C} is coupled to the source terminal of the MOSFET M_{C}. And the drain terminal of the MOSFET M_{C} is coupled to the second terminal of the inductor L1. In the example of FIG. 15, the voltage source V_{C} is employed to supply power to the battery system 150. The MOSFET M_{C} is configured to control the voltage source V_{C} to charge each battery cell. Switch branches are configured to select the battery cell to be charged complementarily.

In the example of FIG. 15, a MOSFET M_{C} is used to control the voltage source V_{C} to charge the battery cells. However, persons of ordinary skill in the art can appreciate that other forms of switch can also be used to realize the function.

FIG. 16 schematically shows an improved battery system 160 in accordance with an embodiment of the present disclosure. Compared to the battery system 150 of FIG. 15, the diodes D1 and D14, and the MOSFETs M1, M7, M8 and M14 are removed in the battery system 160 of FIG. 16. Since fewer components are used in the battery system 160, the size and cost of the system are both reduced and the efficiency is improved. Persons of ordinary skill in the art can appreciate that, in effect, the battery systems 150 and 160 operate in the similar way. The operation of these battery systems will be explained with reference to the battery system 160 of FIG. 16.

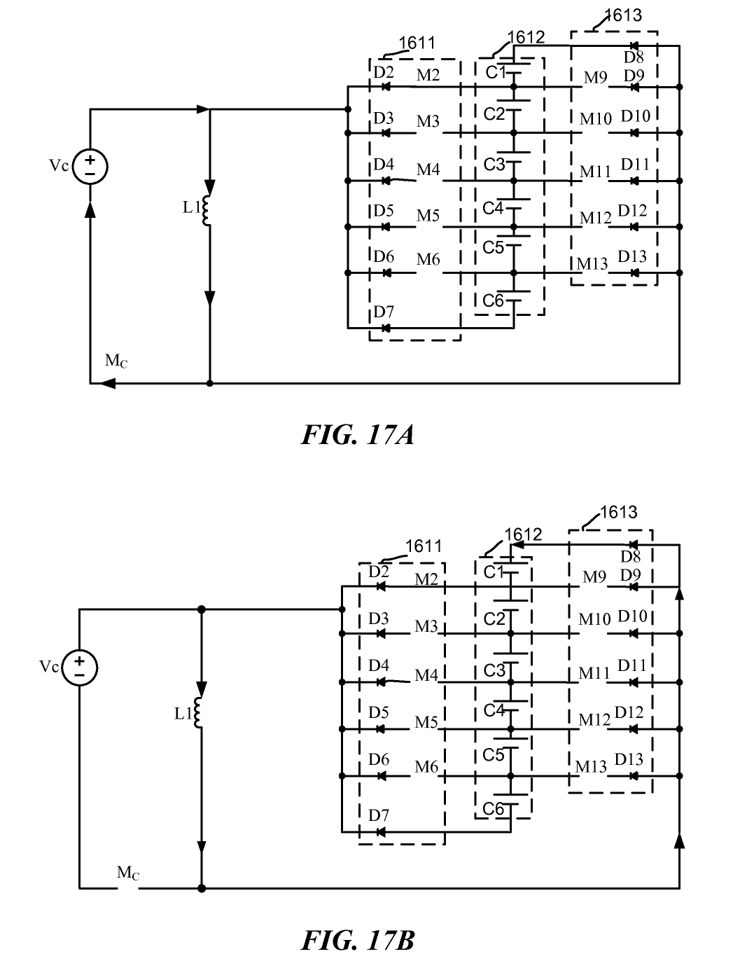

The operation of the battery system 160 is now explained with reference to FIG. 17a and FIG. 17b. The battery system 160 charges a battery cell in the charge stage when the battery cell is not charged to a common full voltage. Take the battery cell C1 for example, when the voltage of C1 is lower than the common full voltage, the MOSFET M2 is turned on, the MOSFET M_{C} is turned on and off with a constant frequency and a constant duty cycle, and the rest MOSFETs are turned off.

When the MOSFET M_{C} is turned on, the operation of the battery system 160 is illustrated in FIG. 17a. Current flows from the voltage source V_{C}, through the inductor L1 and the MOSFET M_{C}. Thereby, energy is stored in the inductor L1. When the MOSFET M_{C} is turned off, the operation of the battery system 160 is illustrated in FIG. 17b. The inductor L1 begins to release energy, with current flowing through the diode D8, the battery cell C1, the MOSFET M2 and the diode D2.

The same explanation applies to other battery cells which need to be charged to the common full voltage. The complementary charge is completed when all the battery cells in the battery pack are charged to the common full voltage in the charge stage.

In some applications, the battery pack may comprise a great number of battery cells (such as 100 battery cells). In these cases, the balance speed of the battery system is limited since there is only one inductor in the battery system. Besides, the MOSFETs and diodes used in the battery system are required to have a high rated voltage, which increases the cost of the system. For example, when the battery pack comprises 24 battery cells and the full voltage of each battery cell is 3.8V, the rated voltage of each MOSFET and diode is (24−1)*3.8=87.4V.

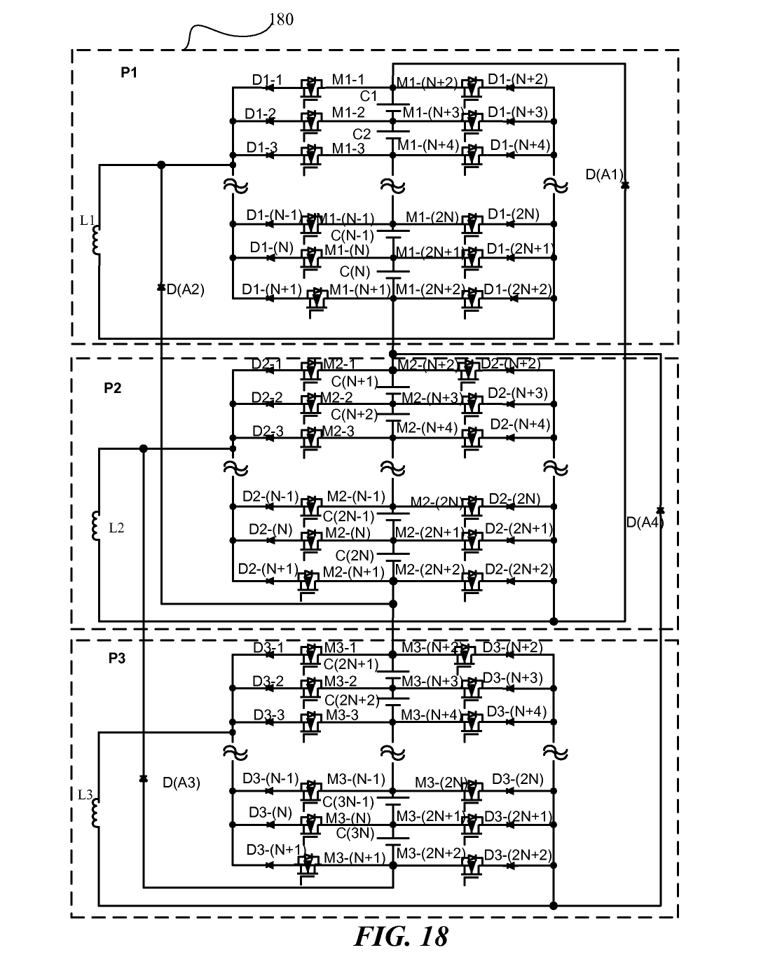

To solve the problem mentioned above, the present disclosure provides an improved battery system with stackable connection. FIG. 18 schematically shows a battery system 180 with stackable connection in accordance with an embodiment of the present disclosure. In the example of FIG. 18, the battery system 180 comprises 3 battery systems 100 (labeled as “P1”, “P2” and “P3” respectively in FIG. 18, hereinafter referred to as battery balance unit) of FIG. 10 and diodes D(A1)˜D(A4). Each of the diodes D(A1)˜D(A4) has an anode and a cathode. The anode of the diode D(A1) is coupled to the second terminal of the inductor L2 in the battery balance unit P2, and the cathode of the diode D(A1) is coupled to the anode of the battery pack in the battery balance unit P1. The diode D(A1) is used to transfer energy from the battery balance unit P2 to P1. The anode of the diode D(A2) is coupled to the cathode of the battery pack in the battery balance unit P2, and the cathode of the diode D(A2) is coupled to the first terminal of the inductor L1 in the battery balance unit P1. The diode D(A2) to transfer energy from the battery balance unit P1 to P2. The anode of the diode D(A3) is coupled to the cathode of the battery pack in the battery balance unit P3, and the cathode of the diode D(A3) is coupled to the first terminal of the inductor L2 in the battery balance unit P2. The diode D(A3) is used to transfer energy from the battery balance unit P2 to P3. The anode of the diode D(A4) is coupled to the second terminal of the inductor L3 in the battery balance unit P3, and the cathode of the diode D(A4) is coupled to the anode of the battery pack in the battery balance unit P2. The diode D(A4) is used to transfer energy from the battery balance unit P3 to P2.

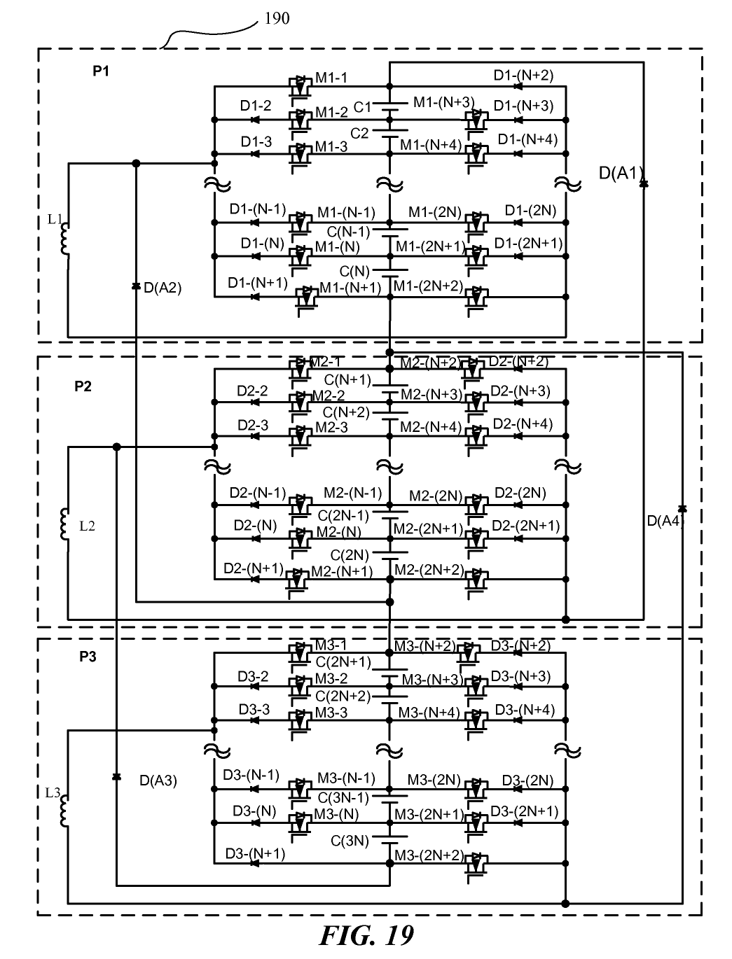

FIG. 19 schematically shows an improved battery system 190 with stackable connection in accordance with an embodiment of the present disclosure. Compared to the battery system 180 of FIG. 18, the MOSFETs M1-(N+2) and M3-(N+1) and diodes D1-1, D1-(2N+2), D2-1, D2-(2N+2), D3-1 and D3-(2N+2) are removed in the battery system 190 of FIG. 19. Since fewer components are used in the battery system 190, the size and cost of the system are both reduced and the efficiency is improved. Persons of ordinary skill in the art can appreciate that, in effect, battery systems 180 and 190 operate in the similar way. The operation of these battery systems will be explained with reference to battery system 190 of FIG. 19, when energy is transferred from the battery balance unit P2 to the battery balance units P1 and P3.

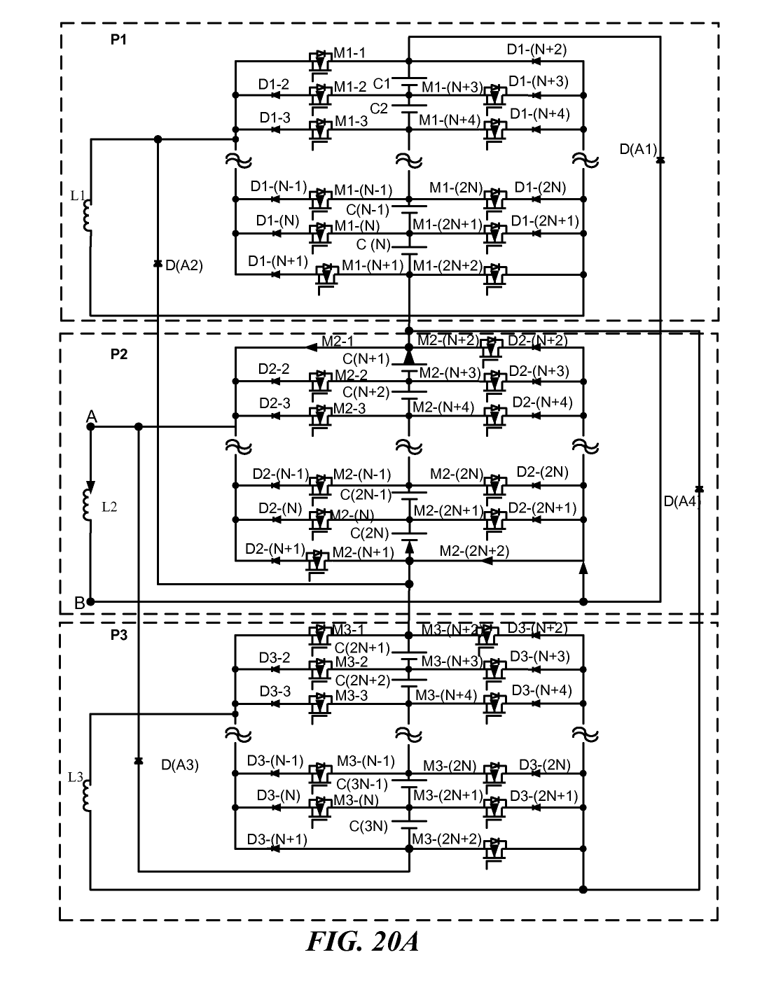

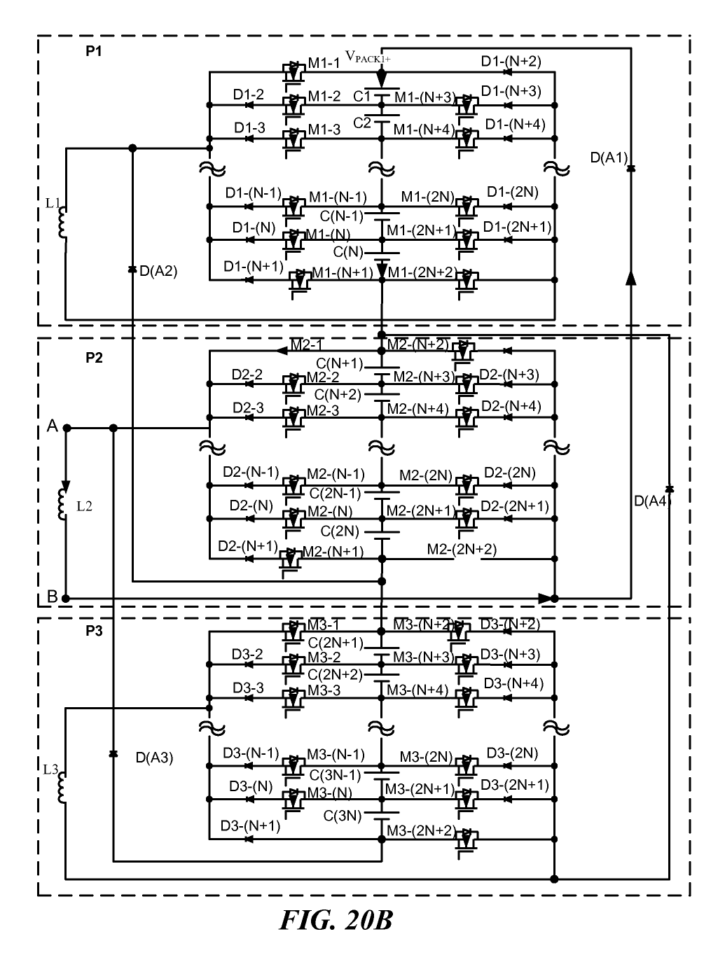

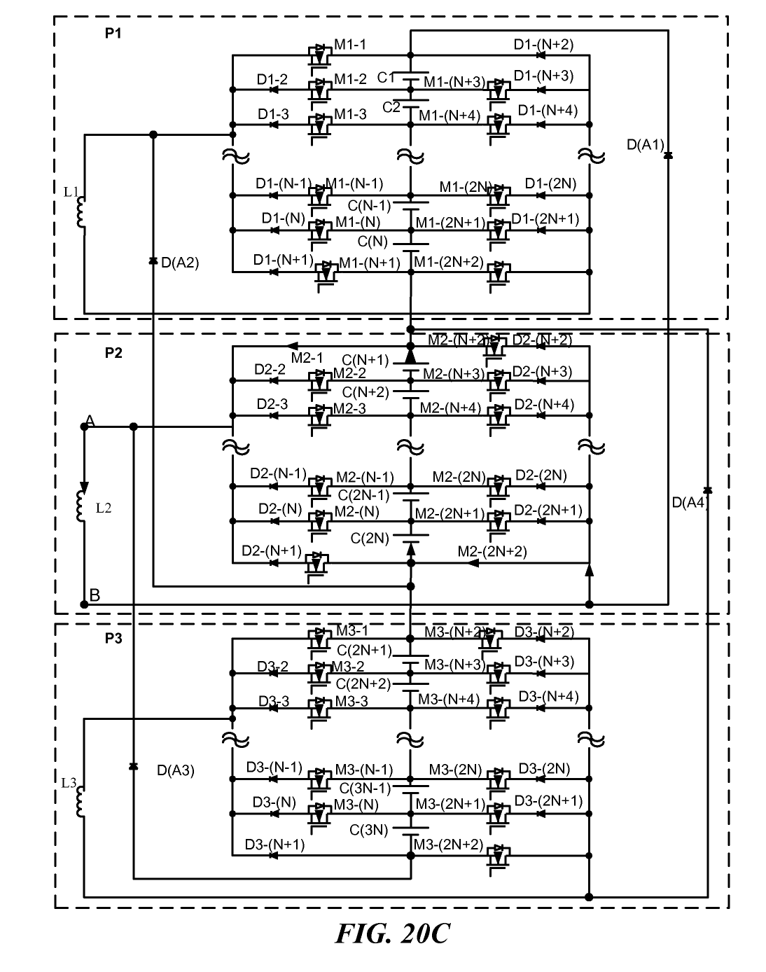

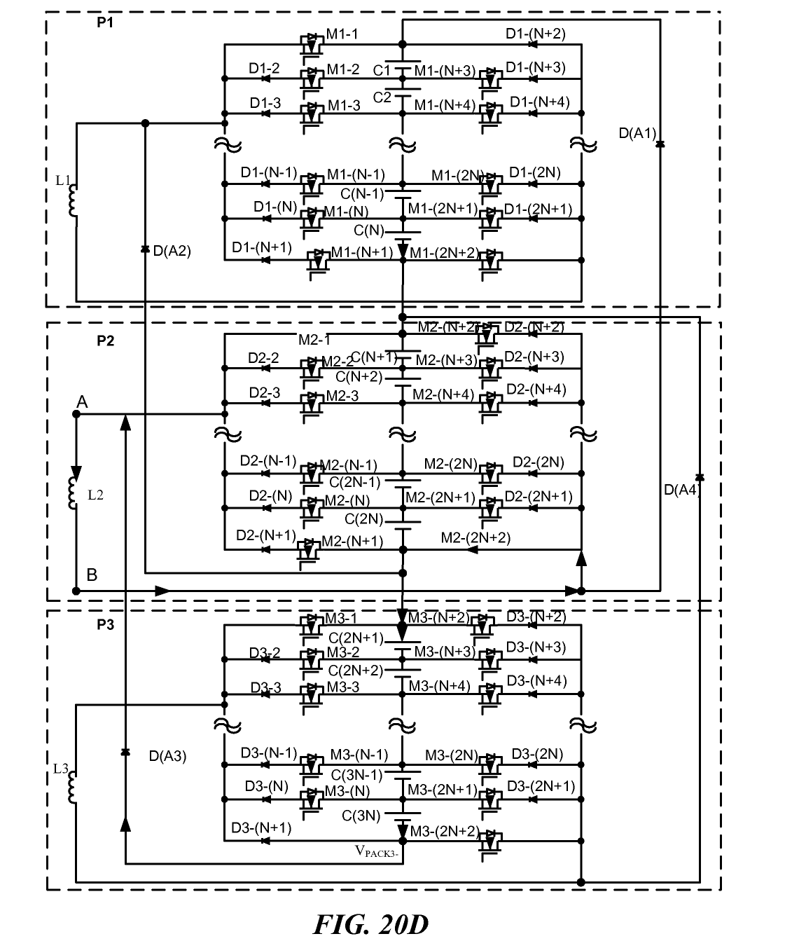

When energy is transferred from the battery balance unit P2 to P1, the MOSFET M2-1 is turned on, the MOSFET M2-(2N+2) is turned on and off with a constant frequency and a constant duty cycle, and other MOSFETs are turned off. When the MOSFET M2-(2N+2) is turned on, the operation of the battery system 190 is illustrated in FIG. 20a. Current flows from the anode of the battery pack in the battery balance unit P2, through the MOSFET M2-1, the inductor L2, and the MOSFET M2-2(N+2), and into the cathode of the battery pack in the battery balance unit P2. Thereby, energy is stored in the inductor L2. Then, as illustrated in FIG. 20b, the MOSFET M2-(2N+2) is turned off. The inductor L2 begins to release energy, with current flowing through the diode D(A1), the battery pack in the battery balance unit P1 and the MOSFET M2-1.

When energy is transferred from the battery balance unit P2 to P3, the MOSFET M2-(2N+2) is turned on, the MOSFET M2-1 is turned on and off with a constant frequency and a constant duty cycle, and other MOSFETs are turned off. When the MOSFET M2-1 is turned on, the operation of the battery system 190 is illustrated in FIG. 20c. Current flows from the anode of the battery pack in the battery balance unit P2, through the MOSFET M2-1, the inductor L2, and the MOSFET M2-2(N+2), and into the cathode of the battery pack in the battery balance unit P2. Thereby, energy is stored in the inductor L2. Then, as illustrated in FIG. 20d, the MOSFET M2-1 is turned off. The inductor L2 begins to release energy, with current flowing through the MOSFET M2-(2N+2), the battery pack in the battery balance unit P3 and the diode D(A3). The battery system 190 of FIG. 19 solves the problems when the battery pack comprises a great number of battery cells, but it still has a high requirement for the rated voltages of MOSFETs. For example, when energy is transferred from the battery balance unit P2 to P1, the diode D(A1) is turned on, the voltage of node B (see FIG. 20b) is equal to the voltage V_{PACK1+} at the anode of the battery pack in the battery balance unit P1. Node B is connected to the anodes of the diodes D2-(N+2), D2-(N+3), . . . , D2-(2N+1), D2-(2N+2), and the voltage V_{PACK1+} is higher than the voltage of the cathodes of the diodes D2-(N+2), D2-(N+3), . . . , D2-(2N+1), D2-(2N+2). Thereby, the diodes D2-(N+2), D2-(N+3), . . . , D2-(2N+1), D2-(2N+2) are turned on, and there is a high voltage stress across the MOSFETs M2-(N+2), M2-(N+3), . . . , M2-(2N+1), M2-(2N+2). The same explanation applies when energy is transferred from the battery balance unit P2 to P3.

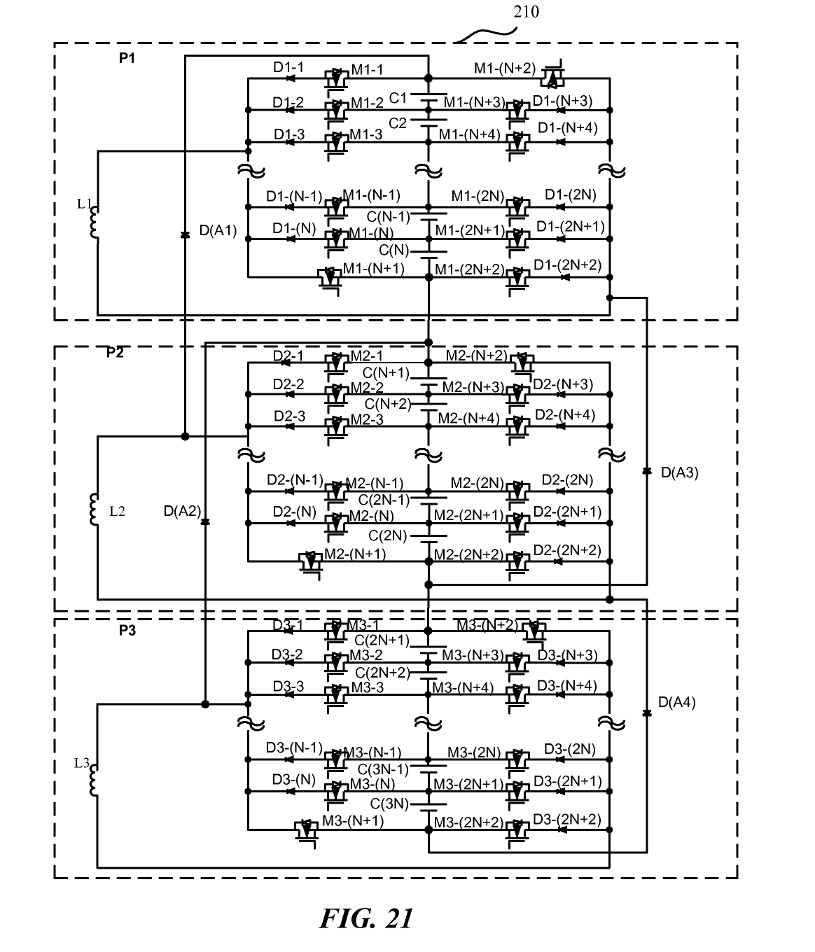

FIG. 21 schematically shows an improved battery system 210 with stackable connection in accordance with another embodiment of the present disclosure. Compared to the battery system 190 of FIG. 19, the rated voltages of the diodes in the battery system 210 of FIG. 21 are relatively high and the rated voltages of the MOSFETs are relatively low. The cost of the battery system 210 is reduced since the diodes is much cheaper than the MOSFETs with the same rated voltage. Compared with the battery system 180 of FIG. 18, the diodes D1-(N+1), D1-(N+2), D2-(N+1), D2-(N+2), D3-(N+1) and D3-(N+2) are removed in the battery system 210. In the battery system 210 of FIG. 21, the MOSFETs M1-(N+1) and M1-(N+2) are used to release the energy of the battery pack in the battery balance unit P1, the MOSFETs M2-(N+1) and M2-(N+2) are used to release the energy of the battery pack in the battery balance unit P2, and the MOSFETs M3-(N+1) and M3-(N+2) are used to release the energy of the battery pack in the battery balance unit P3. The diode D(A1) is used to transfer energy from the battery balance unit P2 to the battery balance unit P1, the diode D(A2) is used to transfer energy from the battery balance unit P3 to the battery balance unit P2, and the diode D(A3) is used to transfer energy from the battery balance unit P2 to the battery balance unit P3.

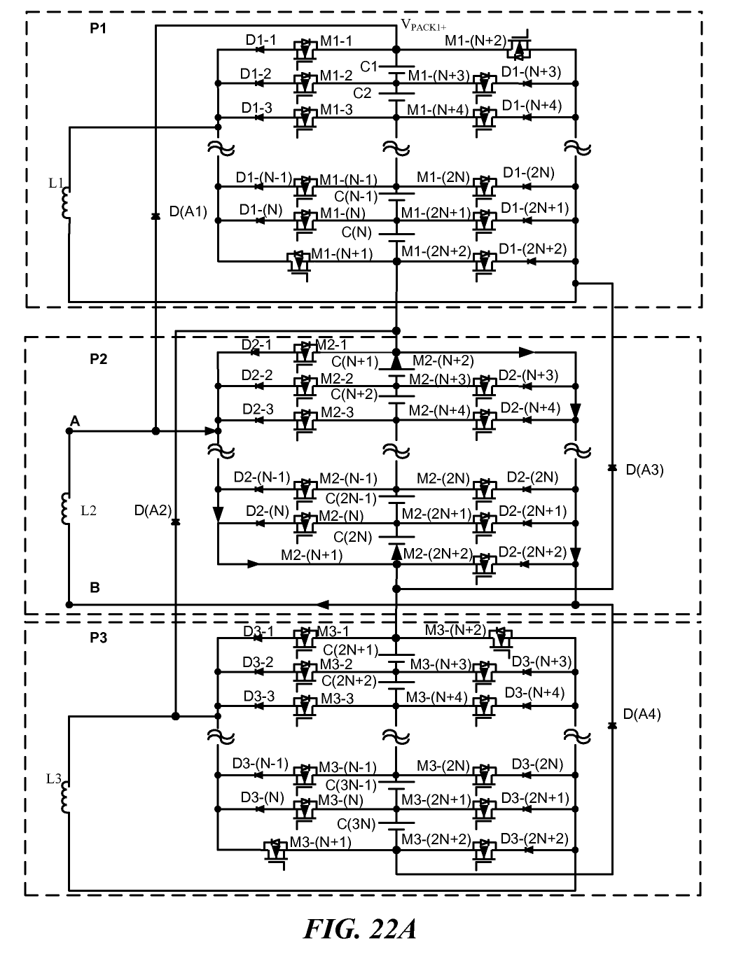

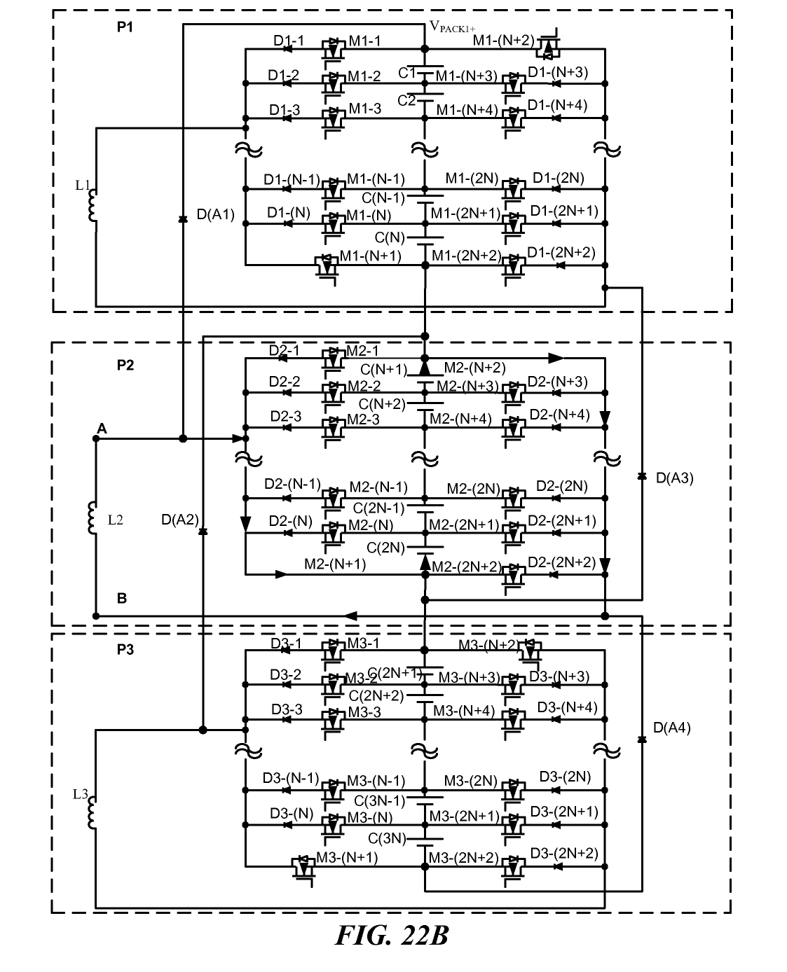

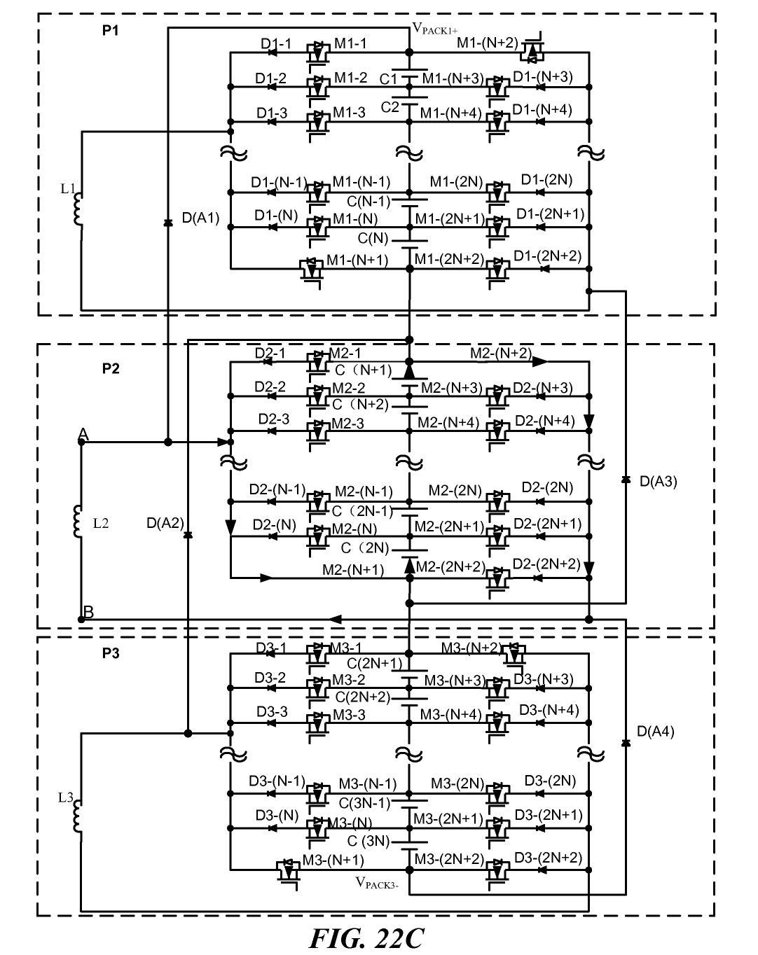

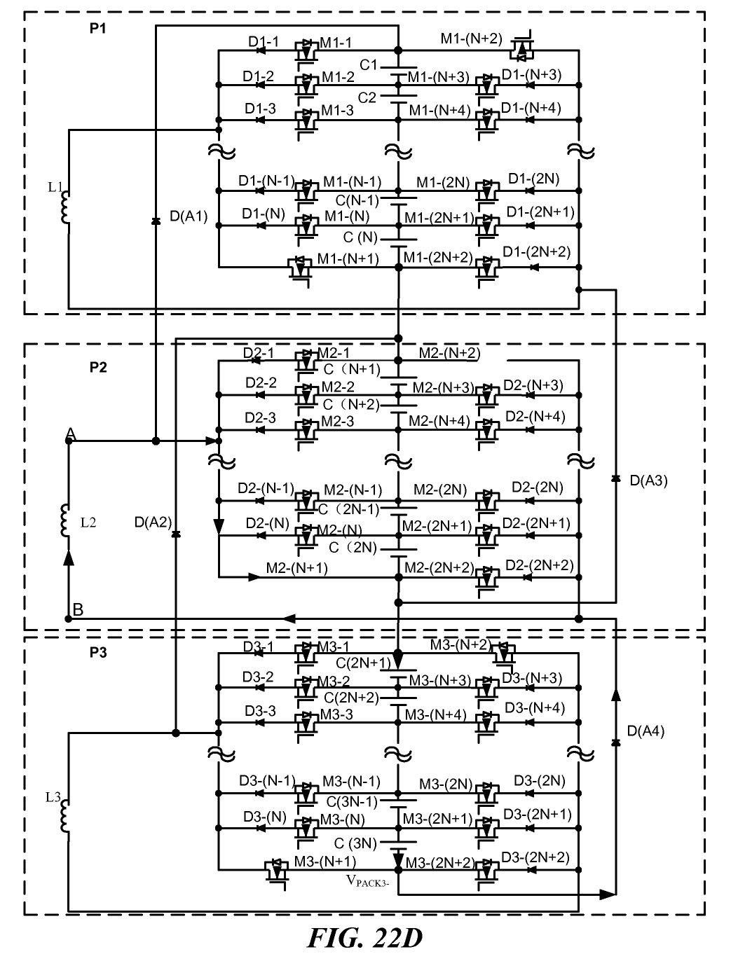

When energy is transferred from the battery balance unit P2 to P1, the MOSFET M2-(N+2) is turned on, the MOSFET M2-(N+1) is turned on and off with a constant frequency and a constant duty cycle, and other MOSFETs are turned off. When the MOSFET M2-(N+1) is turned on, the operation of the battery system 210 is illustrated in FIG. 22a. Current flows from the anode of the battery pack in the battery balance unit P2, through the MOSFET M2-(N+2), the inductor L2, and the MOSFET M2-(N+1), and back into the cathode of the battery pack in the battery balance unit P2. Thereby, energy is stored in the inductor L2. Then, as illustrated in FIG. 22b, the MOSFET M2-(N+1) is turned off. The inductor L2 begins to release energy, with current flowing through the diode D(A1), the battery pack in the battery balance unit P1 and the MOSFET M2-(N+2).

When energy is transferred from the battery balance unit P2 to P3, the MOSFET M2-(N+1) is turned on, the MOSFET M2-(N+2) is turned on and off with a constant frequency and a constant duty cycle, and other MOSFETs are turned off. When the MOSFET M2-(N+2) is turned on, the operation of the battery system 210 is illustrated in FIG. 22c. Current flows from the anode of the battery pack in the battery balance unit P2, through the MOSFET M2-(N+2), the inductor L2, and the MOSFET M2-(N+1), and into the cathode of the battery pack in the battery balance unit P2. Thereby, energy is stored in the inductor L2. Then, as illustrated in FIG. 22d, the MOSFET M2-(N+2) is turned off. The inductor L2 begins to release energy, with current flowing through the MOSFET M2-(N+1), the battery pack in the battery balance unit P3 and the diode D(A4).

When energy is transferred from the battery balance unit P2 to P1, the voltage of node A (see FIG. 22b) equals to the voltage V_{PACK1+} of the anode of the battery pack in the battery balance unit P1. Node A is connected to the cathodes of diodes D2-1, D2-2, . . . , D2-(N), D2-(N+1), and the voltage V_{PACK1+} is higher than the voltages of the anodes of diodes D2-1, D2-2, . . . , D2-(N), D2-(N+1). Thereby, there is a high voltage stress across the diodes D2-1, D2-2, . . . , D2-(N), D2-(N+1). The same explanation applies when energy is transferred from the battery balance unit P2 to P3. As can be seen from above description, the diodes of the battery system 190 resist a relatively high voltage stress, and the rated voltages of MOSFETs can be relatively low expect the MOSFETs M3-(N+2), M2-(N+1), M2-(N+2) and M3-(N+1).

While specific embodiments of the present invention have been provided, it is to be understood that these embodiments are for illustration purposes and not limiting. Many additional embodiments will be apparent to persons of ordinary skill in the art reading this disclosure.

I/We claim:

1. A battery system, comprising:
a battery pack having an anode and a cathode, wherein the battery pack comprises N battery cells connected in series, and each of the battery cells has an anode and a cathode;
a first set of N switch branches, wherein each of the N switch branches has a first terminal and a second terminal, and wherein the first terminals of the first set of N switch branches are coupled together to form a first common node, the second terminals of the first set of N switch branches are coupled to the anode of the N battery cells respectively;
a second set of N switch branches, wherein each of the N switch branches has a first terminal and a second terminal, and wherein the first terminals of the second set of N switch branches are coupled to the cathode of the N battery cells respectively, the first terminals of the second set of N switch branches are coupled together to form a second common node;
an inductor having a first terminal and a second terminal;
a first switch having a first terminal and a second terminal, wherein the first terminal is coupled to the anode of the battery pack, the second terminal is coupled to the first terminal of the inductor;
a second switch having a first terminal and a second terminal, wherein the first terminal is coupled to the first common node, the second terminal is coupled to the second terminal of the inductor;
a third switch having a first terminal and a second terminal, wherein the first terminal is coupled to the first terminal of the inductor, the second terminal is coupled to the second common node; and
a fourth switch having a first terminal and a second terminal, wherein the first terminal is coupled to the second terminal of the inductor, the second terminal is coupled to the cathode of the battery pack.

2. The battery system of claim 1, wherein the first switch, second switch, third switch and fourth switch are all MOSFETs with body diodes.

3. The battery system of claim 1, wherein each switch branch of the first and second sets of N switch branches comprises a MOSFET and a diode serially connected to the MOSFET.

4. The battery system of claim 1, wherein each switch branch of the first and second sets of N switch branches comprises a transistor or two MOSFETs connected back to back.

5. The battery system of claim 2, wherein when the voltage of one battery cell is higher than that of the rest battery cells in the battery pack, the switch branch coupled to the anode of the battery cell in the first set of switch branches and the switch branch coupled to the cathode of the battery cell in the second set of switch branches are kept on, the rest switch branches of the first and second sets of switch branches are kept off, the first switch and the fourth switch are turned off, the second switch and the third switch are turned on and off synchronously, so as to transfer energy from the battery cell to the battery pack.

6. The battery system of claim 2, wherein when the voltage of one battery cell is lower than that of the rest battery cells in the battery pack, the switch branch coupled to the anode of the battery cell in the first set of switch branches and the switch branch coupled to the cathode of the battery cell in the second set of switch branches are kept on, the rest switches of the first and second sets of switch branches are kept off, the second switch and the third switch are turned off, the first switch and the fourth switch are turned on and off synchronously, so as to transfer energy from the battery pack to the battery cell.

7. A battery system, comprising:
a battery pack having an anode and a cathode, wherein the battery pack comprises N battery cells connected in series, and each of the battery cells has an anode and a cathode;
a first set of N+1 switch branches, wherein each of the N+1 switch branches has a first terminal and a second terminal, and wherein the first terminals of the first set of N+1 switch branches are coupled together to form a first common node, the second terminals of the first N switch branches of the first set of N+1 switch branches are coupled to the anode of the N battery cells respectively, and the second terminal of the last switch branch of the first set of N+1 switch branches is coupled to the cathode of the last battery cell;
a second set of N+1 switch branches, wherein each of the N+1 switch branches has a first terminal and a second terminal, and wherein the first terminals of the first N switch branches of the second set of N+1 switch branches are coupled to the anode of the N battery cells respectively, and the first terminal of the last switch branch of the second set of N+1 switch branches is coupled to the cathode of the last battery cell, the second terminals of the second set of N+1 switch branches are coupled together to form a second common node; and
an inductor having a first terminal and a second terminal, wherein the first terminal of the inductor is coupled to the first common node, and the second terminal of the inductor is coupled to the second common node.

8. The battery system of claim 7, wherein each switch branch of the first and second sets of N+1 switch branches comprises a MOSFET and a diode serially connected to the MOSFET.

9. The battery system of claim 7, wherein each switch branch of the first set of N+1 switch branches comprises:
a first NMOS having a drain terminal, a source terminal and a gate terminal, wherein the drain terminal is configured as the second terminal of the switch branch; and
a first diode having an anode and a cathode, wherein the anode is coupled to the source terminal of the first NMOS, the cathode is configured as the first terminal of the switch branch;
and wherein each switch branch of the second set of N+1 switch branches comprises:
a second NMOS having a drain terminal, a source terminal and a gate terminal, wherein the source terminal is configured as the first terminal of the switch branch;
a second diode having an anode and a cathode, wherein the cathode is coupled to the drain terminal of the second NMOS, the anode is configured as the second terminal of the switch branch.

10. The battery system of claim 7, wherein the first switch branch of the first set of N+1 switch branches and the last switch branch of the second set of N+1 switch branches both comprise a MOSFET, the last switch branch of the first set of N+1 switch branches and the first switch branch of the second set of N+1 switch branches both comprise a diode, and the rest switch branches of the first and second sets of N+1 switch branches respectively comprise a MOSFET and a diode serially connected to the MOSFET.

11. The battery system of claim 7, further comprises a voltage source and a switch serially connected to the voltage source, wherein the serially connected voltage source and switch are coupled to the inductor in parallel, so as to provide complementary charge to the battery pack in the charge stage.

12. The battery system of claim 11 wherein each switch branch of the first and second sets of N+1 switch branches comprises a MOSFET and a diode serially connected to the MOSFET.

13. The battery system of claim 9, wherein when the voltage of one battery cell is higher than that of the rest battery cells in the battery pack, the last switch branch of the first set of switch branches and the first switch branch of the second set of switch branches are kept on, the switch branch coupled to the anode of the battery cell in the first set of switch branches and the switch branch coupled to the cathode of the battery cell in the second set of switch branches are turned on and off synchronously, the rest switch branches of the first and second sets of switch branches are kept off, so as to transfer energy from the battery cell to the battery pack.

14. The battery system of claim 9, wherein when a voltage of one battery cell is lower than that of the rest battery cells in the battery pack, the switch branch coupled to the cathode of the battery cell in the first set of switch branches and the switch branch coupled to the anode of the battery cell in the second set of switch branches are kept on, the first switch branch of the first set of switch branches and the last switch branch of the second set of switch branches are turned on and off synchronously, and the rest switch branches of the first and second sets of switch branches are kept off, so as to transfer energy from the battery pack to the battery cell.

15. The battery system of claim 9, wherein when the voltage of a first battery cell is higher than that of the rest battery cells in the battery pack, and the voltage of a second battery cell is lower than that of the rest battery cells in the battery pack, the switch branch coupled to the anode of the first battery cell in the first set of switch branches and the switch branch coupled to the cathode of the first battery cell in the second set of switch branches are turned on and the rest switch branches of the first and second sets of switch branches are turned off until the voltage of the first battery cell is equal to that of the rest battery cells in the battery pack, and then the switch branch coupled to the cathode of the second battery cell in the first set of switch branches and the switch branch coupled to the anode of the second battery cell in the second set of switch branches are turned on and the rest switch branches of the first and second sets of switch branches are turned off, so as to transfer energy from the first battery cell to the second battery cell.

16. A battery system with stackable connection, comprising:
M battery balance units, wherein each battery balance unit comprises:
a battery pack having an anode and a cathode, wherein the battery pack comprises N battery cells connected in series, and each of the battery cells has an anode and a cathode;
a first set of N+1 switch branches, wherein each of the N+1 switch branches has a first terminal and a second terminal, and wherein the first terminals of the first set of N+1 switch branches are coupled together to form a first common node, the second terminals of the first N switch branches of the first set of N+1 switch branches are coupled to the anode of the N battery cells respectively, and the second terminal of the last switch branch of the first set of N+1 switch branches is coupled to the cathode of the last battery cell;
a second set of N+1 switch branches, wherein each of the N+1 switch branches has a first terminal and a second terminal, and wherein the first terminals of the first N switch branches of the second set of N+1 switch branches are coupled to the anode of the N battery cells respectively, and the first terminal of the last switch branch of the second set of N+1 switch branches is coupled to the cathode of the last battery cell, the second terminals of the second set of N+1 switch branches are coupled together to form a second common node; and
an inductor having a first terminal and a second terminal, wherein the first terminal of the inductor is coupled to the first common node, and the second terminal of the inductor is coupled to the second common node;
M−1 pairs of diodes, wherein each pair of the diodes comprises a first diode and a second diode, and wherein the cathode of the first diode is coupled to the anode of the battery pack of the corresponding battery balance unit, and the anode of the first diode is coupled to the second terminal of the inductor of the next battery balance unit, the cathode of the second diode is coupled to the first terminal of the inductor of the corresponding battery balance unit, and the anode of the second diode is coupled to the cathode of the battery pack of the next battery balance unit.

17. The battery system of claim 16, wherein each switch branch of the first and second sets of N+1 switch branches comprises a MOSFET and a diode serially connected to the MOSFET.

18. The battery system of claim 17, wherein each switch branch of the first set of N+1 switch branches comprises:
a first NMOS having a drain terminal, a source terminal and a gate terminal, wherein the drain terminal is configured as the second terminal of the switch branch; and
a first diode having an anode and a cathode, wherein the anode is coupled to the source terminal of the first NMOS, the cathode is configured as the first terminal of the switch branch;
and wherein each switch branch of the second set of N+1 switch branches comprises:
a second NMOS having a drain terminal, a source terminal and a gate terminal, wherein the source terminal is configured as the first terminal of the switch branch;
a second diode having an anode and a cathode, wherein the cathode is coupled to the drain terminal of the second NMOS, the anode is configured as the second terminal of the switch branch.

19. The battery system of claim 16, wherein the first switch branch of the first set of N+1 switch branches and the last switch branch of the second set of N+1 switch branches both comprise a MOSFET, the last switch branch of the first set of N+1 switch branches and the first switch branch of the second set of N+1 switch branches both comprise a diode, and the rest switch branches of the first and second sets of N+1 switch branches respectively comprise a MOSFET and a diode serially connected to the MOSFET.

20. The battery system of claim 16, each of the M battery balance units further comprises a voltage source and a switch serially connected to the voltage source, wherein the serially connected voltage source and switch are coupled to the inductor in parallel, so as to provide complementary charge to the battery pack in the charge stage.
